(19) United States
(12) Patent Application Publication
(10) Pub. No.: US 2012/0158188 A1
(43) Pub. Date: Jun. 21, 2012

(54) ELECTRONIC CONDENSATE OVERFLOW SWITCH

(75) Inventor: Sridhar MADALA, Houston, TX (US)

(73) Assignee: RECTORSEAL CORPORATION, Houston, TX (US)

(21) Appl. No.: 12/973,498

(22) Filed: Dec. 20, 2010

(51) Int. Cl. H01H 35/00; G05D 23/19

(52) U.S. Cl. 700/276; 307/112; 307/118

(57) ABSTRACT

A non-polarized electronic condensate overflow switch uses microprocessor-controlled low-resistance MOSFETs to connect and disconnect power to an HVAC system. The condensate overflow switch derives operational power directly from an AC main and does not need an external power supply or a separate, reference ground line, and therefore does not require configuration in a particular polarity. The microprocessor controls the turning on and off of the power MOSFETs as needed when condensate overflow is detected and also provides more efficient sensing of condensate overflow and other operations, thus minimizing the power needed by the condensate overflow switch. Such a non-polarized electronic condensate overflow switch may be installed within a drain pan, in line with an outlet of the drain pan, or at a remote location away from the drain pan.

### CROSS REFERENCE TO RELATED APPLICATIONS

Not applicable.

### STATEMENT REGARDING FEDERALLY SPONSORED RESEARCH

Not applicable.

### COPYRIGHT NOTIFICATION

Portions of this patent disclosure contain materials that are subject to copyright protection. The copyright owner has no objection to the facsimile reproduction by anyone of the patent document or the patent disclosure as it appears in the Patent and Trademark Office (PTO) patent file or records, but otherwise reserves all copyright rights.

### REFERENCE TO APPENDIX

Not applicable.

### BACKGROUND OF THE INVENTION

1. Field of the Invention

This disclosure relates generally to electronic condensate overflow switches. More particularly, the present disclosure relates to electronic condensate overflow switches that use microprocessor-controlled low-resistance MOSFETs as power switches.

2. Description of the Related Art

Heating, ventilating, and air conditioning (HVAC) systems typically employ evaporator coils to dehumidify and cool the surrounding air. As the air passes over the evaporator coils, moisture in the air causes condensate to form on the surface of the coils. The condensate builds up and drips off the evaporator coils and is collected in a drain pan underneath the coils. The drain pan normally has one or more drain outlets connected to drainpipes that carry away the condensate. This prevents the condensate from overflowing the drain pan and potentially causing damage to attics, ceilings, walls, and the like.

Sometimes, however, the drain outlets and/or drainpipes become clogged or otherwise obstructed with dirt, mold, debris, and the like. This allows the level of condensate in the drain pan to rise and, if left undetected, may result in the condensate eventually overflowing the drain pan. Condensate overflow switches have therefore been developed to detect the rise in the level of condensate, either in the drain pan and/or in the drainpipe. These condensate overflow switches operate to shut off power to the HVAC system when the level of condensate rises to a predefined level, thus avoiding overflow and/or minimizing the amount of overflow.

Existing condensate overflow switches use an electro-mechanical switch that is installed in line between the main power supply, typically 24 Volts of alternating current (V AC), and the HVAC system's control panel. Electro-mechanical switches include, but are not limited to, micro switches, proximity switches, occulting switches, and reed switches. For example, the electro-mechanical reed switch employs a magnet attached to a moving component that is suspended on the condensate. When the condensate level rises, the moving component also rises, bringing the magnet in close proximity to the reed switch. The proximity of the magnet opens the reed switch, causing the 24 V AC power supply to be disconnected from the HVAC system's control panel, thereby shutting off the system and preventing further buildup of condensate.

Electro-mechanical condensate overflow switches, however, suffer from several drawbacks. For example, debris can sometimes interfere with the moving component, preventing it from rising with the condensate. The moving component also tends to be relatively large so as not to fit in small or cramped openings. In addition, the reed switch can become welded shut due to over current flow, thus keeping the HVAC system from turning off. Conversely, the reed switch can also fail to open due to over current arcing and contact pitting, thus preventing the HVAC system from turning on.

Electronic condensate overflow switches have been developed that avoid the moving component problems and the arcing/welding problems associated with the electro-mechanical switches. However, existing electronic switches, which are also installed in line with the 24 V AC power supply powering the HVAC system's control panel, normally require another, separate ground line from which they can reference operational power. This extra ground line, while electrically simple, is an installation headache for most HVAC technicians because they typically need to manually tap into 24 V AC power source to accommodate the additional ground line, and also need to drill extra holes for the additional wires, which may result in incorrect wiring if care is not taken.

One attempt to solve the above extra ground line problem involves using a solid-state switch as the in-line switch to connect and disconnect the HVAC system's 24 V AC power supply. This design relies on a string of diodes in line with the 24V AC power line to derive power for the electronics operating the solid-state switch. However, while the design avoids some of the above problems (e.g., no electro-mechanical issues, such as jammed moving components or welded/pitted relay contacts), the power derivation scheme used by the design inherently wastes several Watts of power in the form of heat that has to be dissipated. Specifically, the presence of the in-line diodes creates a permanent and non-trivial voltage drop in one-half of the AC cycle that, depending on the load current, wastes several Watts of power in the form of dissipated heat.

Accordingly, there is a need for an improved electronic condensate overflow switch that overcomes the shortcomings of existing solutions. More particularly, there is a need for an electronic condensate overflow switch that does not require a ground line and that minimizes the amount of power dissipated.

### SUMMARY OF THE INVENTION

The disclosed embodiments are directed to an electronic condensate overflow switch and methods and systems therefor. The disclosed condensate overflow switch derives operational power directly from an AC main and does not need an external power supply. As such, the condensate overflow switch does not need a separate, reference ground line, and therefore does not require configuration in a particular polarity. In addition, the disclosed condensate overflow switch uses power MOSFETs as an in-line switch to electrically connect and disconnect the AC main from the HVAC system's control panel. The power MOSFETs have extremely low on-state resistance and, therefore, extremely low heat dissipation relative to diode switches and other types of switches. A microprocessor may be used to control the turning on and off of the power MOSFETs. The microprocessor also provides more efficient sensing of condensate overflow and other operations, thus minimizing the power needed by the condensate overflow switch.

In general, in one aspect, the disclosed embodiments are directed to a non-polarized controller for a liquid overflow switch. The non-polarized controller comprises a transistor-based switch connected to an AC power line, the transistor-based switch configured to connect the AC power line electrically to a load and to disconnect the AC power line electrically from the load. The non-polarized controller also comprises a microprocessor connected to the transistor-based switch, the microprocessor configured to control the transistor-based switch to disconnect the AC power line electrically from the load upon occurrence of a predefined event. The non-polarized controller further comprises a DC power supply providing power for the microprocessor and the transistor-based switch, the DC power supply connected to the AC power line and configured to be periodically recharged using power from the AC power line.

In general, in another aspect, the disclosed embodiments are directed to a method of detecting a potential liquid overflow condition using a non-polarized liquid overflow switch in an HVAC system. The method comprises receiving a signal from a liquid sensor probe by a microprocessor in the liquid overflow switch, the signal indicating that the liquid sensor probe has come into contact with a liquid. The method also comprises determining by the microprocessor whether the signal has satisfied a predefined condition and treating the signal as a false indication of a liquid overflow condition by the microprocessor if the signal has not satisfied the predefined condition. The method further comprises opening a transistor-based switch in the liquid overflow switch by the microprocessor to shut off the HVAC system if the signal has satisfied the predefined condition.

In general, in yet another aspect, the disclosed embodiments are directed to a non-polarized electronic condensate overflow switch for an HVAC system the non-polarized electronic condensate overflow switch comprises a mounting structure configured to be attached to a drain pan of the HVAC system, a housing fixedly secured to the mounting structure, one or more liquid sensor probes extending from the housing down to the drain pan, and a processor-based controller disposed within the housing and connected to the one or more liquid sensor probes. The processor-based controller is configured to receive a signal from the one or more liquid sensor probes, the signal being generated when the one or more liquid sensor probes contact a liquid. The processor-based controller is also configured to determine whether the signal represents a valid indication of a liquid overflow condition and to open a transistor-based switch in the electronic condensate overflow switch if the signal represents a valid indication of a liquid overflow condition.

### BRIEF DESCRIPTION OF THE DRAWINGS

The foregoing and other advantages of the disclosed embodiments will become apparent from the following detailed description and upon reference to the drawings, wherein:

FIGS. 1A-1C illustrate exemplary heating, ventilating, and air conditioning systems having an overflow condensate switch according to the present disclosure;

FIG. 2 illustrates an exemplary implementation of the condensate overflow switch according to the present disclosure;

FIG. 3 illustrates another exemplary implementation of the condensate overflow switch according to the present disclosure;

FIG. 4 illustrates an exemplary block diagram of the overflow condensate switch of the present disclosure;

FIG. 5 illustrates an exemplary flowchart of a method that may be used to detect a possible condensate overflow condition according to the present disclosure;

FIGS. 6A and 6B illustrate exemplary flowcharts of methods that may be used to derive power for the overflow condensate switch of the present disclosure;

FIGS. 7A-7E illustrate an exemplary implementation of the overflow condensate switch of the present disclosure; and

FIGS. 8A-8E illustrate another exemplary implementation of the overflow condensate switch of the present disclosure the present disclosure.

### DETAILED DESCRIPTION

The figures described above and the written description of specific structures and functions below are not presented to limit the scope of what has been invented or the scope of the appended claims. Rather, the figures and written description are provided to teach any person skilled in the art to make and use the embodiments for which patent protection is sought. Those skilled in the art will appreciate that not all features of a commercial embodiment are described or shown for the sake of clarity and understanding. Persons of skill in this art will also appreciate that the development of an actual commercial embodiment incorporating aspects disclosed herein will require numerous implementation-specific decisions to achieve the developer's ultimate goal for the commercial embodiment. Such implementation-specific decisions may include, and likely are not limited to, compliance with system-related, business-related, government-related, and other constraints, which may vary by specific implementation, location, and from time to time. While a developer's efforts might be complex and time-consuming in an absolute sense, such efforts would be, nevertheless, a routine undertaking for those of skill in this art having benefit of this disclosure. It must be understood that the principles disclosed and taught herein are susceptible to numerous and various modifications and alternative forms. Lastly, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the figures and are not intended to limit the scope of the disclosed embodiments or the appended claims.

As mentioned above, the disclosed embodiments provide an electronic condensate overflow switch that includes a number of improvements over existing solutions. For example, in some embodiments, the disclosed condensate overflow switch derives or siphons power directly from the AC main. As such, the condensate overflow switch does not need a separate, reference ground line, and therefore does not require configuration in a particular polarity. In addition, the disclosed condensate overflow switch uses power MOSFETs (metal oxide semiconductor field effect transistors) as an in-line switch to electrically connect and disconnect the AC main from the HVAC system's control panel. The power MOSFETs have extremely low on-state resistance and, therefore, extremely low heat dissipation relative to diode switches and other types of switches.

A number of ways are contemplated for siphoning power according to the disclosed embodiments. In one implementation, the electronic condensate overflow switch may siphon power by briefly diverting at least a portion of the power from the AC main used for the HVAC system's control panel and using it to charge one or more reservoir capacitors of the condensate overflow switch instead. In a preferred implementation, the electronic condensate overflow switch may derive power by briefly increasing the series resistance of one or more of the power MOSFETs to create a voltage potential or differential between the drain and source terminals thereof that may then be used to charge the one or more reservoir capacitors.

In any of the above implementations, a microprocessor may be used to control the power MOSFETs. For example, the microprocessor may turn the power MOSFETs on or off in some implementations to interrupt the AC main electrically and reroute power, at least partially, to the reservoir capacitors of the condensate overflow switch. In other implementations, the microprocessor may turn a specific power MOSFET on or off in a specific way to create a voltage potential or differential that may then be used to charge the reservoir capacitors. In either case, the power derivation schemes used by the disclosed condensate overflow switch requires very low duty cycle (e.g., 1% or less) to derive the power, resulting in most (e.g., 99% or more) of the power from the AC main being available to the HVAC control system. The use of a microprocessor also results in more efficient sensing of condensate overflow and other operations, thus minimizing the power needed by the condensate overflow switch. Where power siphoning involves generating a voltage potential or differential at one or more of the power MOSFETs, there is no electrical interruption of the AC main to the HVAC system. This avoids any turn-on-turn-off transients and the associated EMI (electro-magnetic interference) that may arise with such turn-on-turn-off transients.

Other benefits of the disclosed overflow condensate switch include the ability to place condensate-sensing electrodes at locations further away from high current lines if needed. In addition, the compact size of the switch allows it to be installed in restricted or confined spaces, such as inside a drain pan. Failsafe mechanisms in the microprocessor and control electronics automatically disable the HVAC control system upon occurrence of fault conditions (i.e., the switch fails in an opened condition). In some implementations, visual indicators, such as LEDs (light emitting diodes) and the like, may be provided to notify/alert users to various operational modes, such as “normal,” “leak fault,” “testing,” and so forth. Similar visual indicators may also be provided to show users a short-term (e.g., a few days) of operational history. Other advantages of the disclosed overflow condensate switch will become apparent from the following detailed description and the drawings.

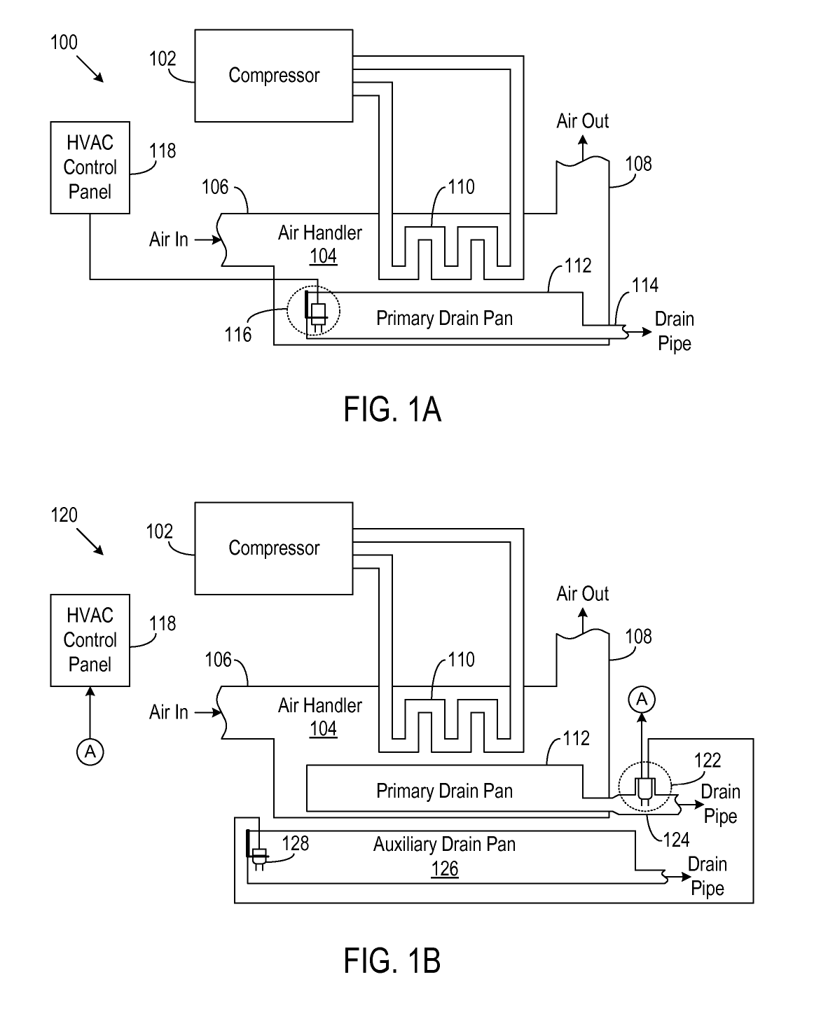

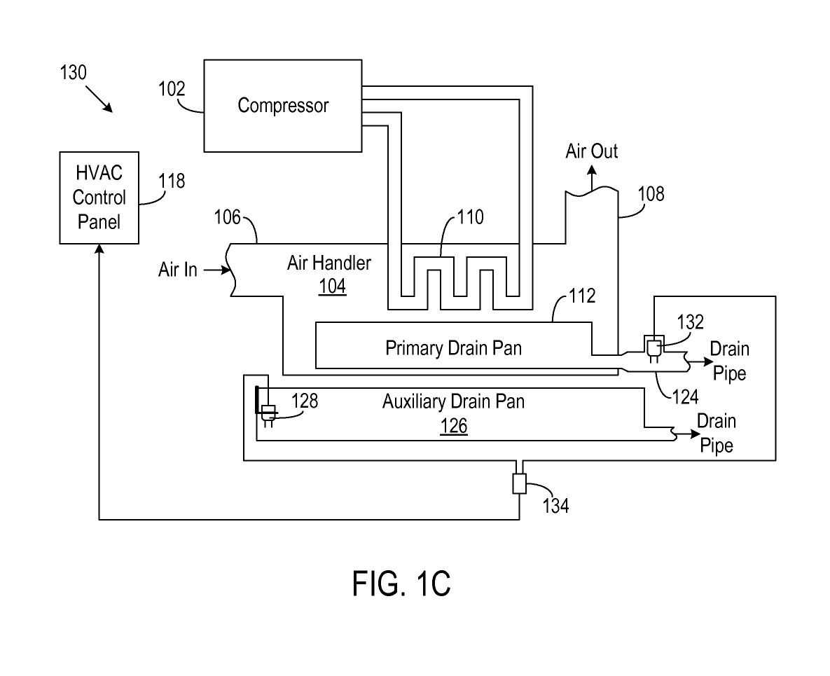

Referring now to FIGS. 1A-1C, exemplary HVAC systems are shown that use at least one implementation of the overflow condensate switch disclosed herein. Turning first to FIG. 1A, an HVAC system 100 is shown of the type typically found in buildings and other commercial structures. The commercial HVAC system 100 is functionally similar to other HVAC systems in that it has a number of common components, including a compressor 102, an air handler 104, one or more air intakes 106, one or more air outlets 108, and one or more evaporator coils 110. These components operate in their usual, well-known manner and therefore a detailed description is omitted here for economy purposes. A primary drain pan 112 is also present to collect condensate from the surface of the evaporator coils 110, and a drain outlet 114 carries the condensate away through a drain pipe (not expressly shown). Most commercial HVAC systems only have a primary drain pan 112 and no secondary or auxiliary drain pan.

In accordance with the disclosed embodiments, the primary drain pan 112 may be provided with a microprocessor-based condensate overflow switch 116 for detecting the level of condensate in the drain pan 112. When that level rises past a certain predefined threshold, the condensate overflow switch 116 is configured to automatically interrupt power to the HVAC system's control panel 118, thereby shutting off the HVAC system to prevent additional condensate from collecting in the drain pan 112. When the level of condensate returns to normal, the condensate overflow switch 116 is configured to restore power to the HVAC system's control panel 118. Preferably, such a condensate overflow switch 116 is sufficiently compact to be mounted within the primary drain pan 112, for example, affixed to one of the walls of the drain pan, due to space limitations resulting from regulatory restrictions.

FIG. 1B shows an example of an HVAC system 120 of the type typically installed in houses or other residential structures. The residential HVAC system 120 is similar to the commercial HVAC system 100 except that it may have an in-line microprocessor-based condensate overflow switch 122 instead of the in-pan switch 116. The in-line condensate overflow switch 122 may be mounted within a pipe-like housing or unit 124 that is connected in line with the outlet of the primary drain pan 112. An example of such an in-line unit 124 may be available from, for example, Rectorseal Corp. of Houston, Texas (see, e.g., Safe-T-Switch Model SS1). General operation of the in-line overflow condensate switch 122 is similar to the general operation off the in-pan switch 116 in that when the level of condensate in the primary drain pan 112 rises past a certain predefined threshold, the condensate overflow switch 122 automatically removes power from the HVAC system's control panel 118 to prevent additional condensate from collecting in the drain pan 112.

In addition, the residential HVAC system 120 may also include an auxiliary drain pan 126 for catching and carrying away any condensate that may have overflowed the primary drain pan 112. Similar to the primary drain pan 112, the auxiliary drain pan 126 may also be provided with a condensate sensor 128 for detecting the level of condensate therein. However, in the implementation shown, the condensate sensor 128 is mainly a probe that detects when the level of condensate has exceeded a predefined threshold and reports the occurrence to the microprocessor-based condensate overflow switch 122. An electrical connection, such as a signal wire, links the condensate sensor 128 to the condensate overflow switch 122. The condensate overflow switch 122 may thereafter operate to cut power to the HVAC system's control panel 118 to stop any further condensate overflow. Due to space limitations resulting from regulatory requirements, the condensate sensor 128 may be mounted within the auxiliary drain pan 126, for example, attached to one of the walls of the drain pan 126. An example of such an in-pan condensate sensor 128 may be available from, for example, the above-mentioned Rectorseal Corp. (see, e.g., Safe-T-Probe Model SP1A).

In the implementation of FIG. 1B, the microprocessor-based condensate overflow switch 122 is installed in line with the primary drain pan 112, whereas the condensate sensor 128 is mounted within the auxiliary drain pan 126. However, the implementation may also be reversed, provided there is adequate spacing, so that the microprocessor-based condensate overflow switch 122 is mounted within the auxiliary drain pan 126, and the condensate sensor 128 is installed in line with the primary drain pan 112. Moreover, in some implementations, neither the primary drain pan 112 nor the auxiliary drain pan 126 may include the microprocessor-based condensate overflow switch. Instead, these drain pans may simply have condensate sensors that detect the condensate, while the microprocessor-based condensate overflow switch may reside at another location physically separate from the drain pans. The condensate sensors may then provide the microprocessor-based condensate overflow switch with signals reflecting whether condensate in the drain pans have exceeded the drain pans' respective predefined thresholds. As mentioned earlier, electrical connections, such as signal wires, may be used to link the condensate sensors to the microprocessor-based condensate overflow switch. An example of a physically separate condensate overflow switch is shown in FIG. 1C.

As can be seen, FIG. 1C illustrates a residential HVAC system 130 similar to the residential HVAC system 120 of the previous figure except that the primary drain pan 112 has an in-line condensate sensor 132 and not a microprocessor-based condensate overflow switch. The auxiliary drain pan 126 meanwhile has the same in-pan condensate sensor 128 seen in the earlier figure. A microprocessor-based condensate overflow switch 134 may then be connected to the condensate sensors 126 and 132 to monitor the condensate levels in the drain pans 112 and 126. In the implementation of FIG. 1C, however, the condensate overflow switch 134 is not located at or within either drain pans, but may be positioned at a remote location away from both drain pans. This arrangement has an advantage in that not only is a single condensate overflow switch being used to monitor condensate levels in multiple drain pans 112 and 126 at once, but the microprocessor-based condensate overflow switch 134 may also be positioned in a more convenient location away from the drain pans 112 and 126, thereby eliminating or at least mitigating any space restrictions surrounding the drain pans.

FIG. 2 illustrates an example of the in-pan condensate overflow switch 116 from FIG. 1A in more detail. As can be seen, the condensate overflow switch 116 has a preferably, but optionally, watertight enclosure or housing 200 containing a microprocessor-based condensate overflow controller 202 and mounted on a support plate 204 that is in turn attached to or otherwise part of a bracket 206 affixed to one of the walls of the drain pan 112. The housing 120 of the condensate overflow switch 116 is generally compact in size so as to allow installation within tight and confined spaces and is preferably about 1 inch long by 0.3 inch thick by 0.5 inch wide (e.g., within ±10%). A pair of liquid sensor probes 208 and 210 extends from the housing 200 through the support plate 204 down to the drain pan 112. The distance between the liquid sensor probes 208 and 210 and the bottom of the drain pan may be adjusted as needed depending on the particular application. Two power lines 212 and 214 extend from the condensate overflow switch 116, one line coming from the AC main and the other line leading to the HVAC control panel 118 to provide power from the AC main to the HVAC control panel 118.

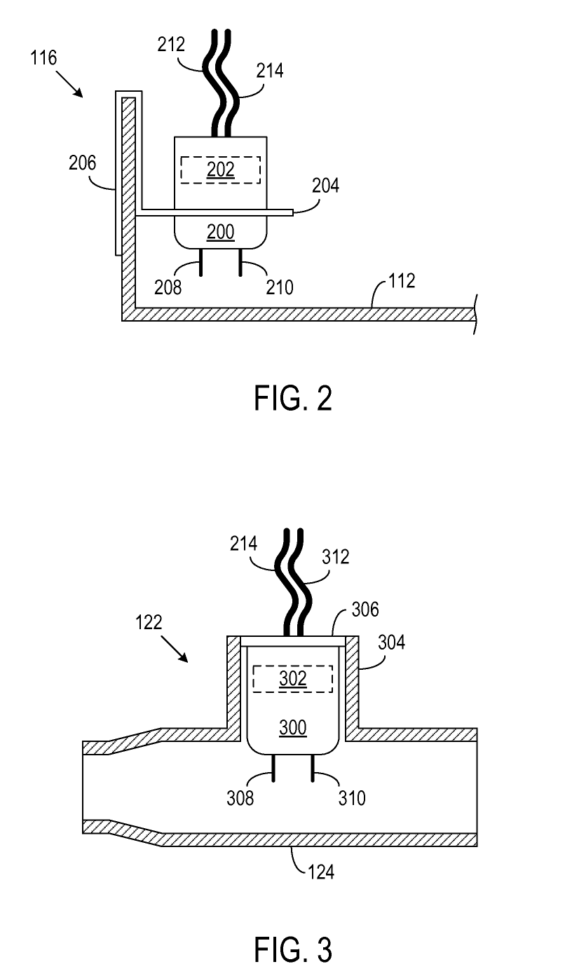

In a similar manner, FIG. 3 illustrates an example of the in-line condensate overflow switch 122 from FIG. 1B in more detail. Such a condensate overflow switch 122 has a preferably, but also optionally, watertight enclosure or housing 300 containing a microprocessor-based condensate overflow controller 302 and disposed within a cup portion 304 of the in-line unit 124. The housing 300 includes or is otherwise attached to a cap or cover 306 that secures the housing 300 of the condensate overflow switch 122 to the cup portion 304 of the in-line unit 124. A pair of liquid sensor probes 308 and 310 extends from the housing 300 down to the in-line unit 124 for detecting condensate therein. The distance between the liquid sensor probes 308 and 310 and the bottom of the in-line unit 124 may be increased or decreased as needed depending on the particular application. Finally, power lines 312 and 314 extend from the condensate overflow switch 122, one line coming from the AC main and the other line leading to the HVAC control panel 118 to provide power from the AC main to the HVAC control panel 118.

The microprocessor-based condensate overflow switch 134 of FIG. 1C is not mounted to or installed in line with a drain pan and does not include any liquid sensor probes. Therefore, the housing for this overflow switch 134 may be any suitable enclosure or housing that is capable of containing a microprocessor-based condensate overflow controller similar to the overflow controller 202 or 302 of FIG. 2 or 3. As such, a detailed description of the enclosure or housing for the microprocessor-based condensate overflow switch 134, as well as any mounting structures that may be used with such housing is omitted here for economy purposes.

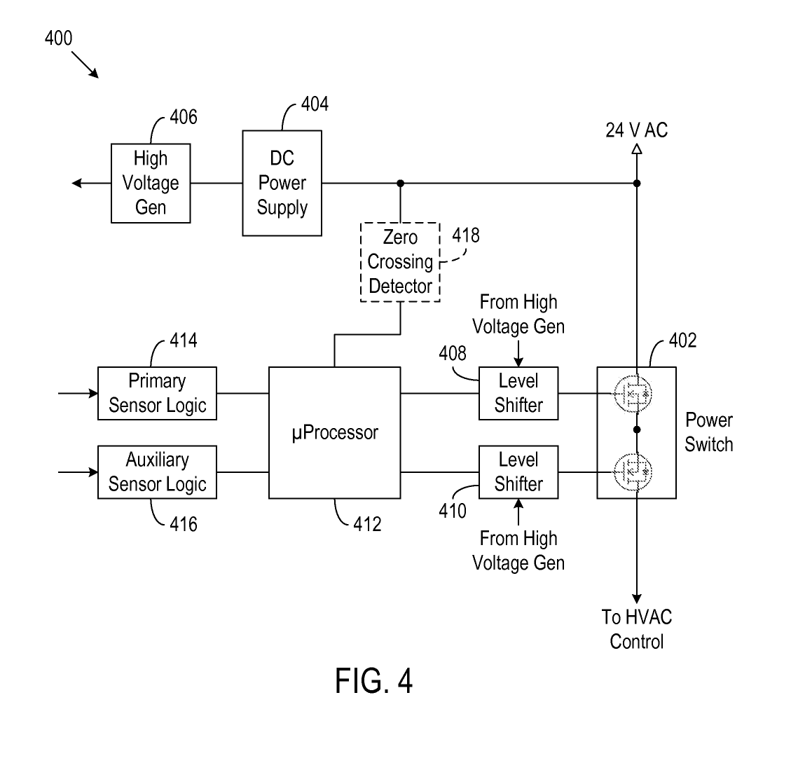

Referring next to FIG. 4, an exemplary implementation of a microprocessor-based condensate overflow controller 400 that may be used with the condensate overflow switch 116, 122, or 134 is shown. As can be seen, the condensate overflow controller 400 of the disclosed embodiment is illustrated in terms of some of its functional components. These functional components may be in the form of discrete electrical components and/or integrated circuits mounted on a printed circuit board, or as highly integrated one-chip solutions that provide all required functionality on a single semiconductor device. It is also possible, of course, for those having ordinary skill in the art to combine the above approaches without parting from the scope of the disclosed embodiments.

In the implementation shown, the condensate overflow controller 400 includes a power switch 402 having low-resistance power MOSFETs connected back-to-back such that they share a common source terminal. A direct current (DC) power supply 404 is also present for providing DC power to the various electronic components of the condensate overflow controller 400. The DC power supply 404 also feeds a high-voltage generator 406 that is configured to generate one or more of the high voltage levels (e.g., 4 V, 6 V, 8 V, 10 V, etc.) required by the gates of the low-resistance power MOSFETs. Of course, for MOSFETs with gate terminals that can accept standard logic levels (e.g., 1.5 V, 3.3 V, 5.0 V, etc.), the high-voltage generator 406 may be omitted. In any event, level shifters 408 and 410 may then use the high voltage generated by the high-voltage generator 406 to shift the voltage level from a standard logic level (e.g., 3.3 V) to a power MOSFET-compatible logic level (e.g., 10 V) for any signals going to the power MOSFETs.

The DC power supply 404 of FIG. 4, unlike the AC main, is not an independent and continuous source of power. Rather, the DC power supply 404 must rely on regular or periodic charging of its charge storage elements, which may be one or more reservoir capacitors (not expressly shown here), in order to maintain enough charge to power the components of the condensate overflow controller 400. Depending on the size of the one or more reservoir capacitors, the charge may need to be replenished fairly frequently, for example, once per second, to maintain a sufficient level of power in the DC power supply 404. To this end, the condensate overflow controller 400 may be configured to siphon power from the AC main, which is typically a 24 V AC power line, to recharge the DC power supply 404.

In accordance with the disclosed embodiments, a microprocessor 412 is provided in the condensate overflow controller 400 for controlling the various operations of the controller 400. These operations include, but are not limited to: (i) turning on and off the MOSFETs in the power switch 402 to electrically connect and disconnect the 24 V AC power line from the HVAC system's control panel; and (ii) siphoning power from the 24 V AC power supply to charge the DC power supply 404. Such a microprocessor 412 may be any suitable device that is capable of being programmed with specific functions, including a microcontroller, a field programmable gate array (FPGA), an application-specific integrated circuit (ASIC), and the like. Preferably, the microprocessor 412 is an ultra low power device, such as an MSP430 series microcontroller available from Texas Instruments, Inc., and other similar devices. Finally, primary and auxiliary sensor logic 414 and 416 are present to process any signals from the liquid sensor probes and provide such processed signals to the microprocessor 412.

In general operation, upon initial startup, no power is available to the MOSFETs of the power switch 402 and therefore the MOSFETs are in a non-conductive state at this time. As a result, power on the 24 V AC power line is routed at least partially to the DC power supply 404 to charge the one or more reservoir capacitors therein. Once the charge in the one of more reservoir capacitors builds up to a certain level, for example, 3.3 V, the microprocessor 412 and various other components of the condensate overflow controller 400 begin to power on. The microprocessor 412 thereafter initializes itself and begins executing its programmed instructions, including, among other things, turning on the MOSFETs of the power switch 402. Once turned on, the low on-state resistance of the power MOSFETs allows all or nearly all of the power on the 24 V AC power line to flow to the HVAC system's control panel.

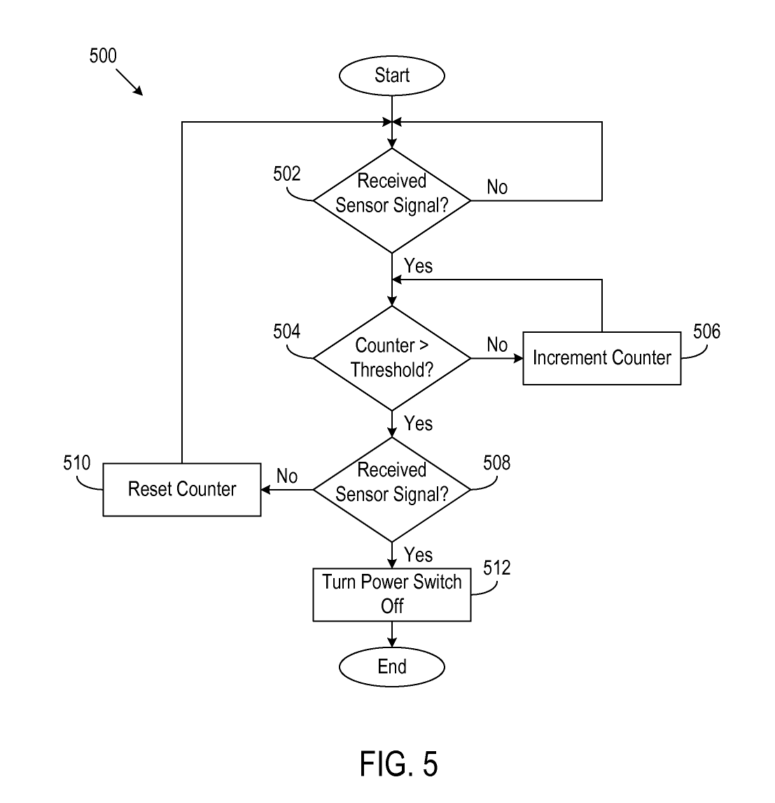

One benefit provided by the above arrangement is the ability to configure the microprocessor 412 to detect and reject potentially false condensate overflow indications from the liquid sensor probes. For example, the microprocessor 412 may be programmed to require that any signal from the liquid sensor probes be solid, or steady, for a predefined period of time before establishing that an overflow condition exists. In other implementations, the microprocessor 412 may be programmed to identify a false signal by other methods, such as detecting an occlusion or lack thereof. An example of a false signal detection arrangement based on requiring the signal from the liquid sensor probes to be solid for a predefined period of time is illustrated in FIG. 5 in accordance with the disclosed embodiments.

As can be seen in FIG. 5, an exemplary flowchart 500 is shown for a method that may be used by the microprocessor 412 to handle condensate overflow signals. The flowchart 500 begins at block 502, where a determination is made as to whether a signal has been received from the sensor logic 414 or 416 for the liquid sensor probes. If the answer here is no, the flowchart 500 returns to block 502 to continue checking for a signal from the liquid sensor probes. If the answer is yes, a determination is made at block 504 as to whether an overflow counter has reached a predefined threshold (e.g., 5, 10, 15, etc.). If the answer is no, the overflow counter is incremented at block 506, and the flowchart 500 loops back to block 504 to check whether the counter has reached the predefined threshold, effectively creating a timer with a predefined time interval. Once the predefined threshold is reached, another determination is made at block 508 as to whether the signal is still present. This ensures that an overflow condition will not be indicated unless the signal from the liquid sensor probes is present for at least the length of time it takes the overflow counter to reach its predefined threshold. If the answer here is no, then the overflow counter is reset at block 510, and the flowchart 500 returns to block 502 to continue checking for a signal from the liquid sensor probes 126 and 128. If the answer is yes, then the power switch 402 is turned off at block 512 to disconnect the 24 V AC power line electrically from the HVAC system's control panel. Using the microprocessor 412 in this manner to implement an overflow counter may help lessen the probability of a false condensate overflow condition being indicated.

An additional benefit of the microprocessor 412 is that it may be used to control more efficiently the siphoning of power from the 24 V AC power supply. As discussed above, in one implementation, power siphoning may be accomplished by briefly and precisely interrupting the 24 V AC power line to divert it, at least partially, to the DC power supply 404 (see FIG. 4) to charge one or more reservoir capacitors therein. In another implementation, power siphoning may be accomplished by briefly and precisely increasing the series resistance of the power switch 402 so that a predefined voltage potential or differential is developed across the power switch 402. This voltage differential across the power switch 402, which may be about 5 V (e.g., within ±10%), may then be used to charge the one or more reservoir capacitors in the DC power supply 404.

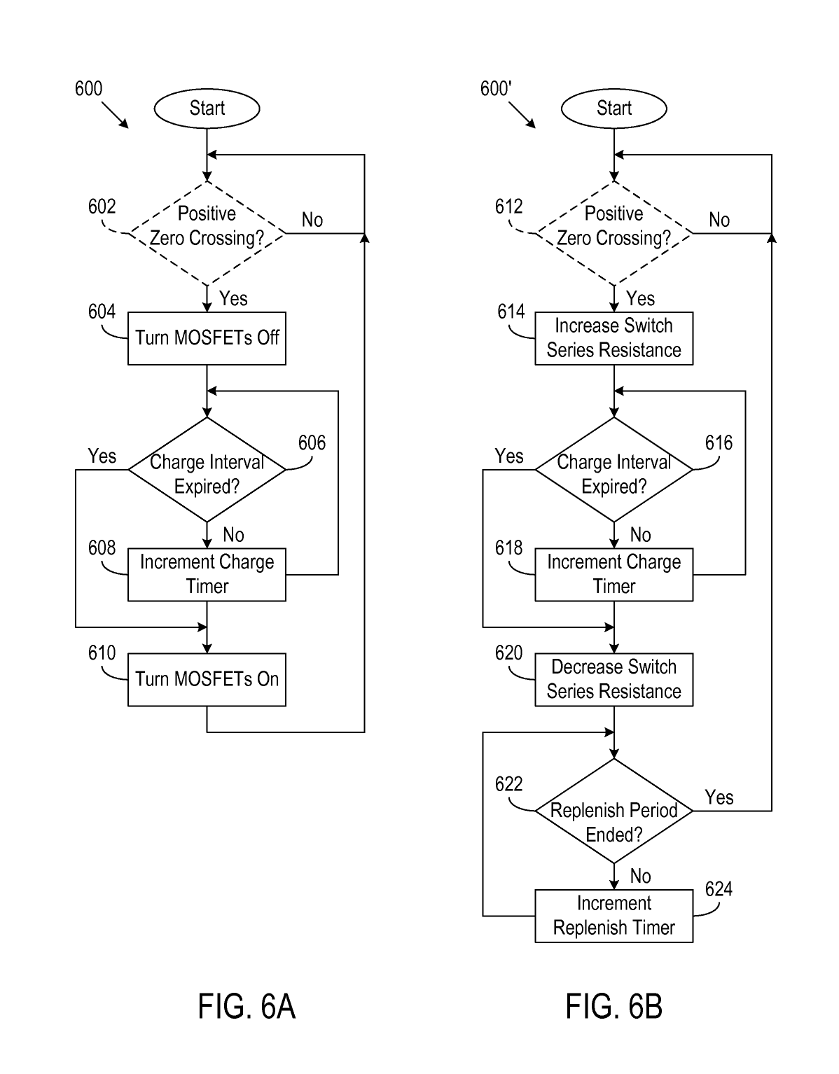

In accordance with the disclosed embodiments, the microprocessor 412 may be used to time precisely the power siphoning intervals discussed above. In the electrical interruption technique, for example, the microprocessor 412 may be used to turn off the MOSFETs of the power switch 402 precisely at a first point in time and to turn them back on precisely at a second point in time. In the increased series resistance technique, the microprocessor 412 may be configured to start precisely the interval when the series resistance of the power switch 402 is increased and to end precisely that interval at the proper moment in time. The use of the microprocessor 412 to control these power-siphoning intervals is illustrated in FIGS. 6A and 6B.

Turning first to FIG. 6A, an exemplary flowchart 600 for a method is shown that may be used to siphon power by using the microprocessor 412 to electrically interrupt the 24 V AC power line. In the method depicted here, power is siphoned very briefly, but very precisely, with every positive AC cycle of the 24 V AC power line. As can be seen, the flowchart 600 begins at block 602, where a determination is made as to whether a negative-to-positive zero crossing has been detected in the 24 V AC power line. The zero crossing detection, however, is an entirely optional step that is not needed in every implementation and, accordingly, block 602 is shown here in dashed lines. In any event, if the answer is no, then the flowchart 600 returns to block 602 to continue monitoring for such a zero crossing (where block 602 implemented). If the answer is yes, then the flowchart proceeds to block 604, where the MOSFETs of the power switch 402 are turned off, thus electrically disconnecting the 24 V AC power supply from the HVAC system's control panel. Because the MOSFETs are no longer conducting, a voltage develops across the DC power supply 404 that begins to charge the one or more reservoir capacitors therein. The flowchart 600 thereafter proceeds to block 606, where a determination is made as to whether the power siphon interval has expired, for example, by checking a charge timer. If the answer is no, then the charge timer is incremented at block 608, and the flowchart 600 returns to block 606 to continue checking whether the timer has expired. If the answer is yes, then the flowchart 600 proceeds to block 610, where the MOSFETs of the power switch 402 are turned back on, thereby reconnecting the 24 V AC power supply to the HVAC system's control panel. The flowchart 600 thereafter returns to the optional block 602 to await the next negative-to-positive zero crossing.

Note in the flowchart 600 of FIG. 6A that, where positive zero crossing detection is used, the zero crossing detection block 602 and the loop associated therewith function to control how often the DC power supply 404 is recharged. In particular, the zero crossing detection block 602 ensures that the recharging of the DC power supply 404 occurs once for every AC cycle. For implementations that do not employ positive zero crossing detection, alternative arrangements may be made to regulate or otherwise control the number of times the recharging of the DC power supply 404 may occur. For example, a timer may be used to control the recharging so that such recharging takes place once with each timer reset. Other techniques may be used by those having ordinary skill in the art to control the recharging of the DC power supply 404 without departing from the scope of the disclosed embodiments.

Turning next to FIG. 6B, an exemplary flowchart 600′ for a method is shown that may be used to siphon power by using the microprocessor 412 to increase the series resistance of the MOSFETs of the power switch 402. In this method, power is again siphoned very briefly and precisely, but only for one positive AC cycle of the 24 V AC power line per second. The flowchart 600′ begins at block 612, where a determination is again optionally made as to whether a negative-to-positive zero crossing has been detected in the 24 V AC power line. If the answer is no, then the flowchart 600′ returns to block 612 to continue monitoring for the zero crossing (where block 612 is implemented). If the answer is yes, then the flowchart proceeds to block 614, where the series resistance of the power switch 402 is increased. Because of the increased series resistance, a voltage differential of about 5 V arises that begins to charge the one or more reservoir capacitors of the DC power supply 404. The flowchart 600′ thereafter proceeds to block 616, where a determination is made as to whether the power siphon interval has expired, again for example, by checking a charge timer. If the answer is no, then the charge timer is incremented at block 618, and the flowchart 600′ returns to block 616 to continue checking whether the timer has expired. If the answer is yes, then the flowchart 600′ proceeds to block 620, where the series resistance of the power switch 402 is returned back to the milliohm level, thereby removing the voltage differential that had been arisen earlier. The flowchart 600 thereafter proceeds to block 622, where a determination is made as to whether a replenishment period (e.g., one second) has expired, for example, by checking a replenishment timer. If the answer is no, then the flowchart 600′ increments the replenishment timer and returns to block 622 to check whether the replenishment period has expired. If the answer is yes, then the flowchart 600′ returns to optional block 612 to await the next negative-to-positive zero crossing.

The foregoing examples illustrate a simple “fixed time” control scheme, where the microprocessor 412 controls the MOSFETs of the power switch 402 for a predefined period of time to siphon power. This predefined period of time may be, for example, a fraction of the positive half of a standard 60 Hz AC cycle (e.g., half a millisecond, or until the AC cycle reaches 6 V) where the electrical interruption scheme of FIG. 6A is used. Where the “series resistance” power siphoning scheme is used, this predefined period of time may be one-half, preferably the positive half, of a standard 60 Hz AC cycle (or 6.33 milliseconds) every second, resulting in an effective duty cycle of less than 1%. Note that even during this very small period of time, the HVAC system's control panel is still being provided with sufficient current (albeit with a slight voltage drop). For both of the above power siphoning schemes, assuming a 24 V AC supply and a 5 A current in the HVAC system's control panel, it is estimated that the amount of power lost to power siphoning is still less than 1 Watt out of a total of 120 Watts, or less than 1%.

Alternatively, in some embodiments, a “synchronized on demand” control scheme may be used that regularly or periodically senses the reservoir capacitor charge levels and times the power siphoning sequence such that the MOSFETs are turned off, or a voltage differential is developed, for only a small portion (e.g., 1 to 2 milliseconds) of the AC cycle instead of the half cycle (8.33 milliseconds) mentioned earlier, thereby further reducing any heat dissipation in the condensate overflow controller 400. However, based on testing of prototype designs, even the simple “fixed time” power siphoning schemes were found to be more than adequate for proper operation of the circuit without excessive heat generation in the controller 400.

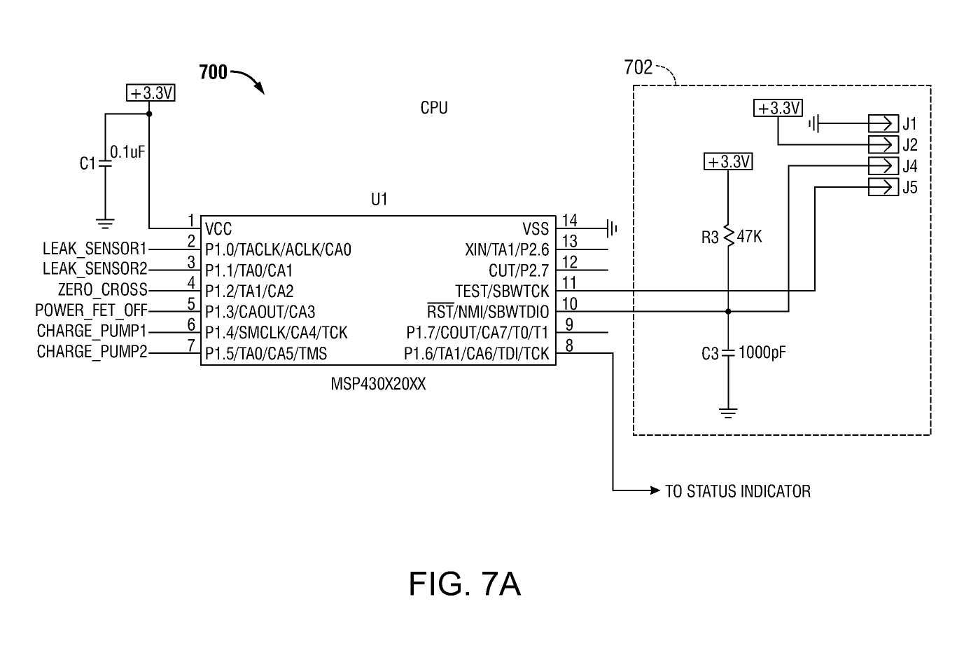

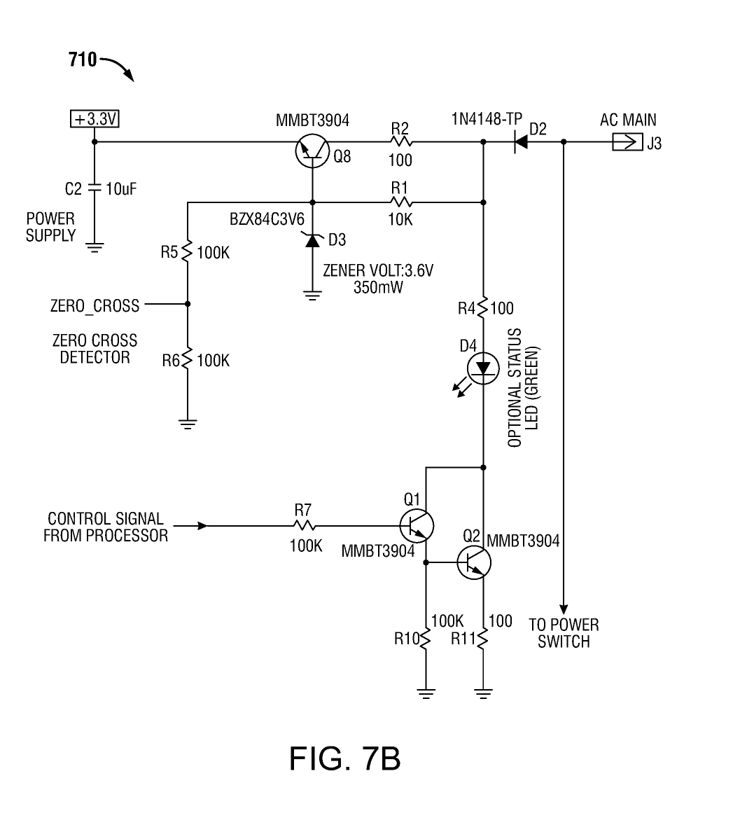

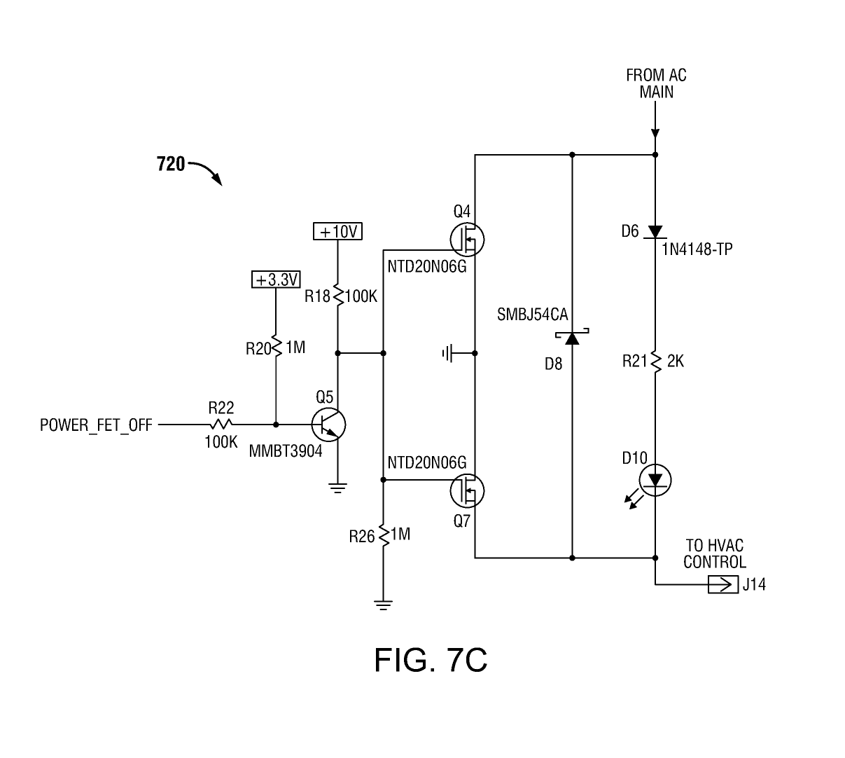

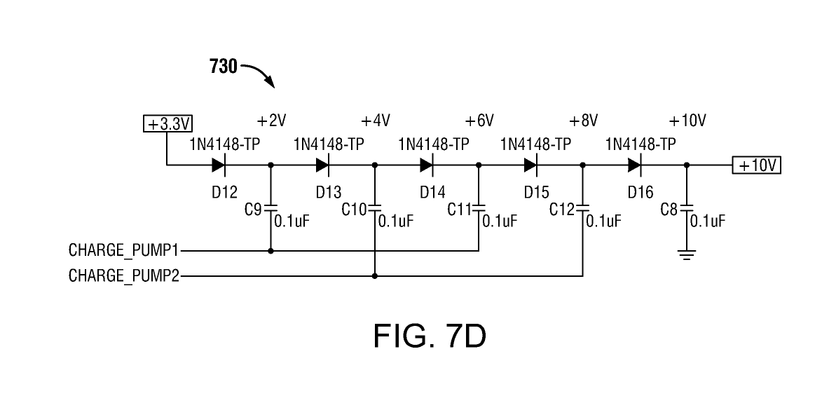

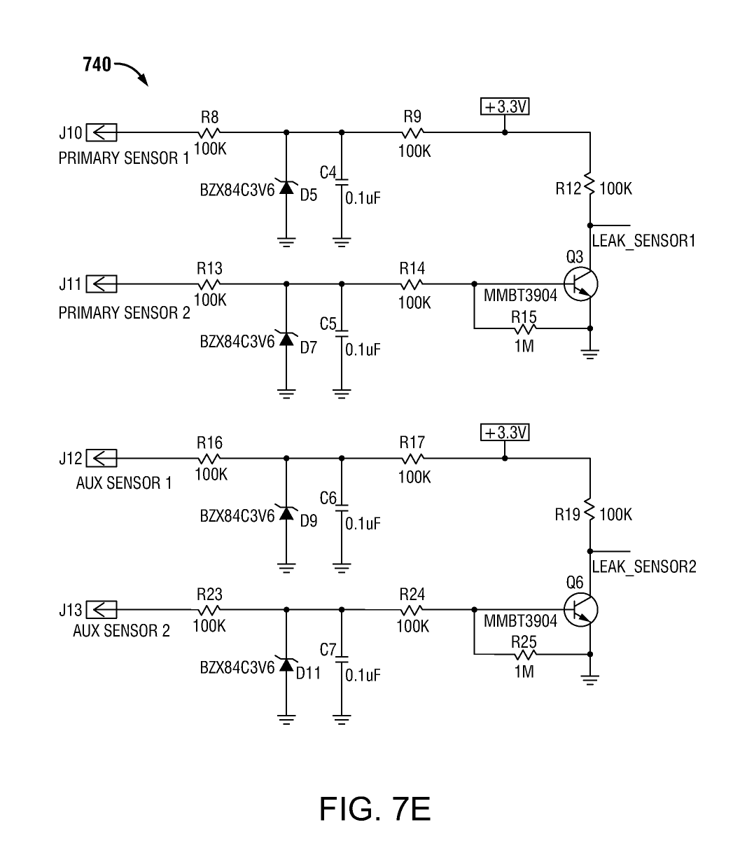

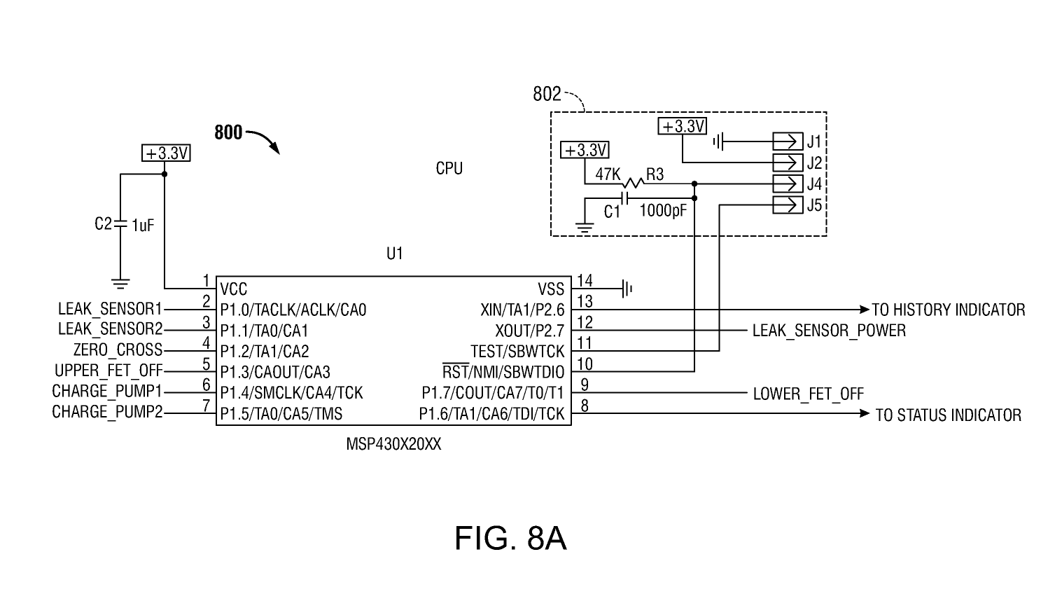

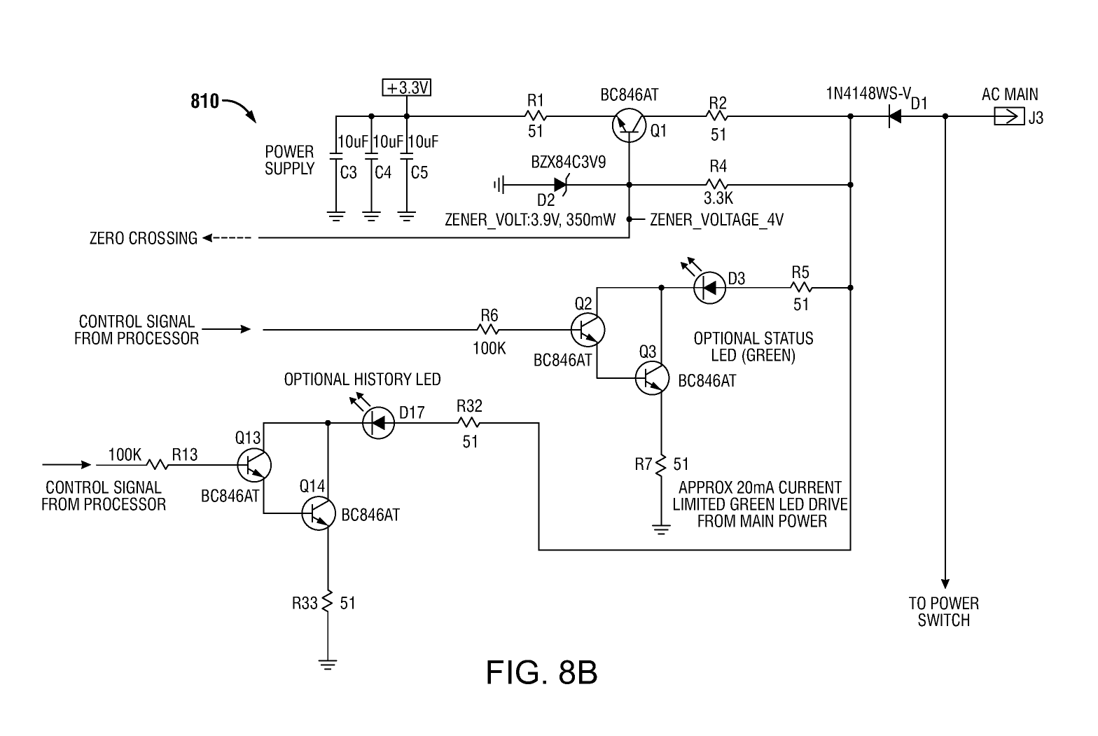

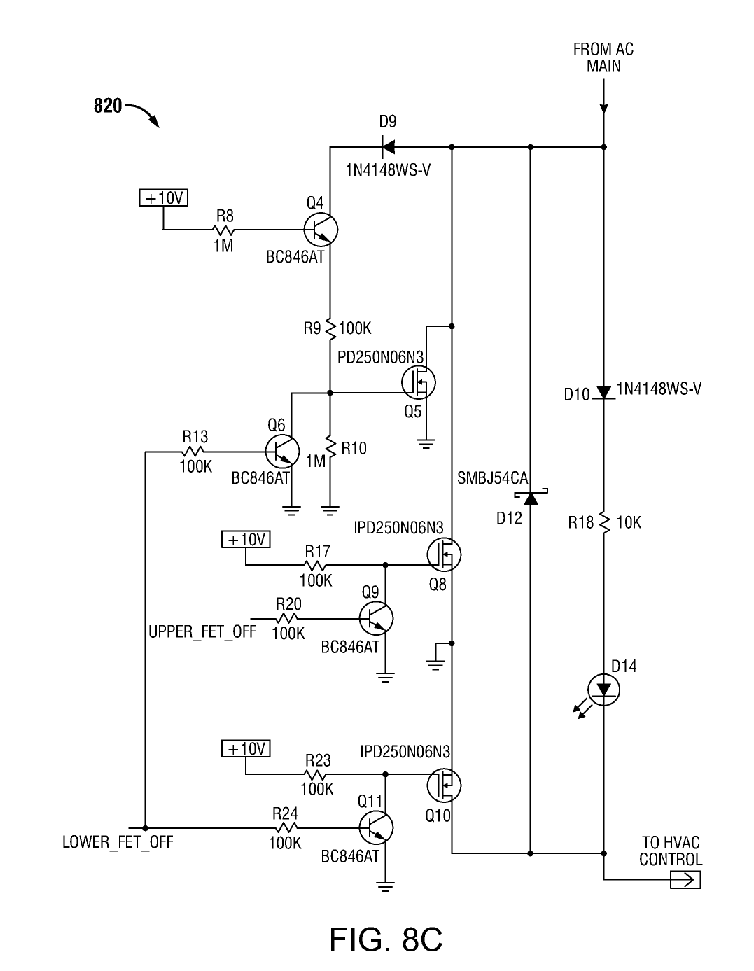

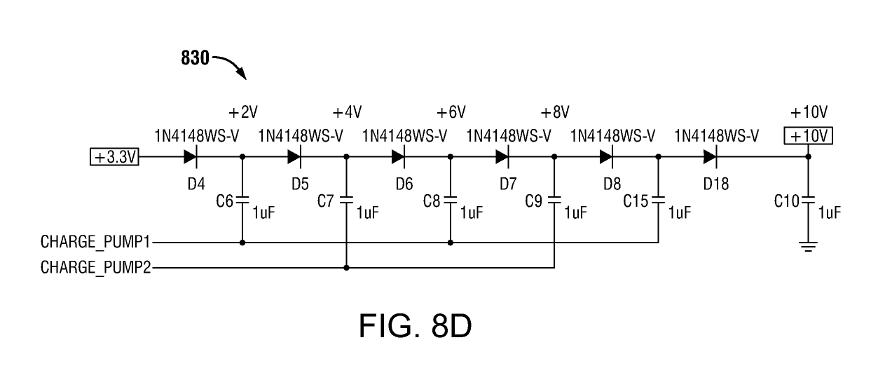

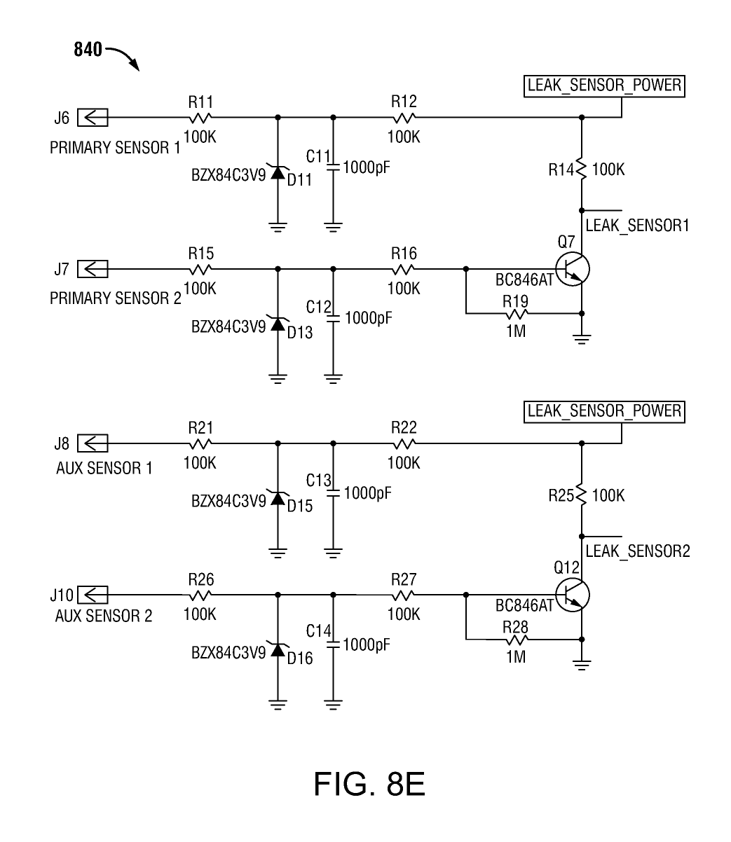

Thus far, a number of exemplary embodiments have been shown and described in the form of functional components and block diagrams. Following now in FIGS. 7A-7E and FIGS. 8A-8E are specific implementations of the exemplary embodiments discussed above. The implementations of FIGS. 7A-7E generally correspond to the embodiments of FIG. 6A, and the implementations of FIGS. 8A-8E generally correspond to the embodiments of FIG. 6B. Note that although FIGS. 7A-7E and FIGS. 8A-8E may show specific part numbers (and hence component manufacturers) and specific component values, other part numbers and component values may certainly be substituted by those having ordinary skill in the art without departing from the scope of the disclosed embodiments.

Referring first to FIG. 7A, a specific implementation 700 of the microcontroller 412 according to some embodiments is illustrated. As can be seen, the microcontroller used here is an ultra low power MSP430 series microcontroller available from Texas Instruments, Inc. Similar microcontrollers from other manufacturers may of course be used without departing from the scope of the disclosed embodiments. In the depicted example, the power pin, pin 1, of the microcontroller is connected to a 3.3 V power supply from the DC power supply 404. A bypass capacitor C1 is optionally connected between the 3.3 V power supply and ground. Pins 2 and 3 of the microcontroller are connected to and receive input signals (LEAK_SENSOR1 and LEAK_SENSOR2) from the primary and auxiliary sensor logic, respectively, of the liquid sensor probes, while pin 4, the zero crossing detector pin, is optionally connected to and receives a zero crossing input signal (ZERO_CROSS).

Pin 5 outputs a MOSFET control signal (POWER_FET_OFF) for shutting off the MOSFETs of the power switch 402. Pins 6 and 7 output charge pump signals (CHARGE_PUMP1 and CHARGE_PUMP2) that cause the high voltage generator 406 to generate the high voltage required by the MOSFETs. Finally, pin 8 outputs a status signal for driving an LED to indicate the status circuit (e.g., green light means normal operation, red light means possible fault condition, etc.).

The reaction of the microcontroller to the above input signals and the timing and sequence of its various output signals are as generally described above and may be programmed in (or uploaded to) the microcontroller via programming pins 10 and 11 and the connections shown at 702 in a manner known to those having ordinary skill in the art. In some embodiments, it is also possible to access and extract various types of information concerning the operation of the condensate overflow controller 400, such as the number of overflows detected, system errors, and the like, through the programming pins 10 and 11 of the microcontroller and the connections shown at 702.

FIG. 7B illustrates a specific implementation 710 of the DC power supply 404 and optional zero crossing detector 418 according to the disclosed embodiments. As seen in this figure, the DC power supply 404 comprises a reservoir capacitor C2 that receives charge from the 24 V AC line through a standard diode D2 (Part No. 1N4148), resister R4, and standard bipolar junction transistor (BJT) Q8 (Part No. MMBT3904), all connected as shown. The capacitor C2, once charged, can provide a 3.3 V power supply to the other components of the condensate overflow controller 400 for a predefined amount of time and up to one second. The optional zero crossing detector 418 comprises a Zener diode D3 (Part No. BZX84C3V6) that is connected between ground and the 24 V AC line through a resistor R1 and diode D2. The voltage at the Zener diode D3 is connected to the base of the transistor Q8 and is further divided by a voltage divider composed of resistors R5 and R6. The voltage between the resistors R5 and R6 serves as the optional zero crossing signal and is inputted to the optional zero crossing detector pin, pin 4, of the microcontroller.

An optional status indicator LED D4 is also connected to the 24 V AC line through resistor R4 and diode D2. The LED D4 is driven by the status indicator control signal from the microcontroller, pin 8, via the base terminal of BJT transistor Q1, which shares a common collector with BJT transistor Q2 and has its emitter terminal connected to the base terminal of transistor Q2 as well as to ground through a resistor R10. The collector terminal of transistor Q2 is similarly connected to ground through a resistor R11. Both the transistors Q1 and Q2 may be Part No. MMBT3904.

FIG. 7C illustrates a specific implementation 720 of the power switch 402 according to the disclosed embodiments. In the implementation shown, the power switch 402 may be composed of two low-resistance MOSFETs Q4 and Q7 (Part No. NTD20N06G) with their source terminals connected together and to ground as shown. The drain terminal of MOSFET Q4 is connected to the 24 V AC line, while the drain terminal of MOSFET Q7 is connected to the HVAC system's control panel. This arrangement allows current on the 24 V AC line to be conducted through the MOSFETs in either direction by virtue of the alternating voltage of the 24 V AC power line. The gate terminals of both MOSFETs Q4 and Q7 are connected to the collector terminal of a BJT transistor Q5 (Part No. MMBT3904), which collector terminal is in turn connected to a 10 V power line provided by the high-voltage generator 406 (see FIG. 7D). The base terminal of transistor Q5 is connected to pin 5 of the microcontroller through a resistor R5 and receives the MOSFET control signal (POWER_FET_OFF) from the microcontroller for turning the MOSFETs Q4 and Q7 on and off as needed. A pull-up resistor R20 connects the base of transistor Q5 to a 3.3 V power supply.

In some embodiments, a parallel network composed of (i) a transient voltage suppressor D8 (Part No. SMBJ54CA) that suppresses any transient voltages appearing on the 24 V AC line, and (ii) a series connection of diode D6 (Part No. 1N4148), resistor R21, and LED D10, may be connected in parallel with the MOSFETs Q4 and Q7 as shown. The LED D10 operates (lights up) to indicate any time there is a loss of power to the HVAC system's control panel for any reason.

FIG. 7D illustrates a specific implementation 730 of the high-voltage generator 406 according to the disclosed embodiments. As can be seen, the high-voltage generator 406 may include a series connection of five diodes D12, D13, D14, D15, and D16 (all Part No. 1N4148TP), with each diode's cathode connected to the adjacent diode's anode, as shown. The anode of the first diode in the series, D12, is connected to the 3.3 V line, while the cathode of the last diode in the series, D16, is connected to the 10 V power line. Capacitors C9 and C11 each have one terminal connected to the cathodes and anodes, respectively, of diodes D12 & D13 and D14 & D15, and the other terminal connected to the first charge pump signal (CHARGE_PUMP1) of the microcontroller, pin 6. Capacitors C10 and C12 each have terminal connected to the cathodes and anodes, respectively, of diodes D13 & D14 and D15 & D16, and the other terminal connected to the second charge pump signal (CHARGE_PUMP2) of the microcontroller, pin 7. A fifth capacitor C8 has one terminal connected to the cathode of the last diode D16 and the 10 V power line and the other terminal connected to ground. As can be seen, when asserted by the microcontroller, each successive junction between the diodes D12, D13, D14, D15, and D16 has an incrementally higher voltage than the previous junction once the various capacitors C8, C9, C10, C11, C12 are charged so as to provide a 10 V supply line. The 10 V supply line may then be used by the level shifter 408 and 410 to shift the voltage level from a standard logic level up to a MOSFET logic level for any signals provided to the MOSFETs Q4 and Q7.

Finally, FIG. 7E illustrates a specific implementation 740 of the primary and auxiliary sensor logic 414 and 416 for the liquid sensor probes (not expressly shown) according to the disclosed embodiments. In the illustrated example, one of the liquid sensor probes may be connected to the primary sensor logic 414 via a resistor R8. Resistor R8 is in turn connected to another resistor R9 that is itself connected to a resistor R12. A parallel combination of a Zener diode D5 (Part No. BZX84C3V6) and capacitor C4 are connected between the two resistors R8 and R9 and ground. This combination of resistor R8, Zener diode D5, and capacitor C4 ESD protection to limit any potential damage to the sensor logic 414 that may result from electrostatic discharge and also suppresses any radio frequency noise that may be present. Resistor R12, in turn, is connected to the collector terminal of a BJT transistor Q3 (Part No. MMBT3904), which collector terminal is connected to one of the sensor signal pins, pin 2, of the microcontroller for providing a sensor signal (LEAK_SENSOR1) to the microcontroller. The emitter terminal of BJT transistor Q3, the other and, is connected to its base terminal via a resistor R25. This base terminal of BJT transistor Q3 is also connected to a resistor R14 that is in turn connected to another resistor R13. A parallel combination of Zener diode D7 (Part No. BZX84C3V6) and capacitor C5 are connected between the two resistors R14, R13, and ground. The resistor R13 also allows a second liquid sensor probe to be connected to the primary sensor logic 414.

The auxiliary sensor logic 416 is constructed in a manner similar to the primary sensor logic 414 using similar components and therefore will not be described in detail here.

In general operation, upon detection of a negative-to-positive zero crossing (where such a zero crossing is implemented), MOSFETs Q4 and Q7 are turned off for approximately 0.5 ms out of the 16.66 ms of the positive half of each 60 Hz AC cycle (e.g., within ±10%) in order to siphon power from the 24 V AC line and thereby replenish the charge on the reservoir capacitor C2. Once replenished in this manner, the reservoir capacitor C2 can provide approximately 1 second (e.g., within ±10%) of operational power to the condensate overflow controller. The expected average power consumption of the circuit is less than 100 μA at 3.3 V. Condensate overflow conditions are sensed when a small current (e.g., 1 μA) is conducted via the condensate in the drain pan through probe contacts J10 & J11 and into the base of BJT transistor Q3.

FIGS. 8A-8E illustrate an implementation of the condensate overflow controller 400 similar to the implementation shown in FIGS. 7A-7E. However, the implementation of FIGS. 8A-8E does not siphon power by electrically interrupting the power supplied to the HVAC system's control panel. Rather, the implementation of FIGS. 8A-8E employs a voltage differential that is created by increasing the series resistance of power switch 402 to siphon power.

Referring to FIG. 8A, an implementation 800 of the microcontroller 412 similar to the implementation 700 in FIG. 7A is shown according to some embodiments. As with the earlier implementation, the microcontroller 412 here may be an ultra low power MSP430 series microcontroller available from Texas Instruments, Inc. The power pin, pin 1, of the microcontroller is again connected to the 3.3 V power supply, and a bypass capacitor C2 may be connected between the 3.3 V power supply and ground. The same input signals and output signals from the implementation 700 of FIG. 7A are seen again on the same pins here (i.e., LEAK_SENSOR1, LEAK_SENSOR2, ZERO_CROSS (optional), CHARGE_PUMP1, and CHARGE_PUMP2). Pin 8 again drives a status indicator LED. Pin 5, however, generates only an upper MOSFET control signal (UPPER_FET_OFF) for shutting off the upper of the two MOSFETs, while pin 9 generates a lower MOSFET control signal (LOWER_FET_OFF) for shutting off the lower of the two MOSFETs. In addition, pin 12 provides power to the sensor logic of the liquid sensor probes via a signal LEAK_SENSOR_POWER.

As before, the reaction of the microcontroller to the above input signals and the timing and sequence of its various output signals are as generally described and may be programmed in (or uploaded to) the microcontroller via programming pins 10 and 11 and the connections shown at 802 in a manner known to those having ordinary skill in the art. In some implementations, it is also possible to access and extract various types of information concerning the operation of the condensate overflow controller 400, such as the number of overflows detected, system errors, and the like, through the programming pins 10 and 11 of the microcontroller and the connections shown at 802.

FIG. 8B illustrates an implementation 810 of the DC power supply 404 and optional zero crossing detector 418 according to the disclosed embodiments. As can be seen in this figure, the DC power supply 404 comprises three parallel-connected reservoir capacitors C3, C4, and C5 that receive charge from the 24 V AC line through a standard diode D1 (Part No. 1N4148), resistor R2, and BJT Q1 (Part No. BC846AT), all connected in the manner shown. The capacitors C3, C4, and C5 thusly charged provide a 3.3 V power supply to the other components of the condensate overflow controller 400 for a predefined amount of time. A Zener diode D2 (Part No. BZX84C3V9) is connected between ground and the 24 V AC line through a resistor R4 and diode D1. The Zener diode D2 together with transistor Q1 form a kind of voltage regulator that keeps the voltage across the reservoir capacitors C3, C4, and C5 at or near 3.3 V. To this end, the voltage at the cathode of Zener diode D2 is provided to the base terminal of transistor Q1, which voltage further functions as the optional zero crossing signal (ZERO_CROSS) to the zero crossing detector pin, pin 4, of the microcontroller.

An optional status indicator LED D3 is also connected to the 24 V AC line through a resistor R5 and diode D1 as shown. The LED D3 provides a status indication (e.g., normal, fail, etc.) that is driven by the status indicator control signal from the microcontroller, pin 8, via the base of BJT transistor Q2, which shares a common collector with BJT transistor Q3 and has its emitter terminal connected to the base terminal of transistor Q3. The collector terminal of transistor Q3 is similarly connected to ground through a resistor R7. Both of the transistors Q2 and Q3 may be Part No. BC846AT. An additional optional history indicator LED D17 may also be provided for providing several days of history information about the condensate overflow controller 400, depending on the capability of the microcontroller used. The history indicator LED D17 may be connected to the 24 V AC line via an arrangement of BJT transistors Q13 & Q14 and resistors R32, R31 & R33 that are similar to their counterparts for the status indicator LED D3. A control signal from pin 13 of the microcontroller may be connected to the base of transistor Q13 through resistor R31 for driving the history indicator LED D17.

FIG. 8C illustrates an implementation 820 of the power switch 402 according to the disclosed embodiments. In the implementation shown, the power switch 402 may be composed of two low-resistance MOSFETs Q8 and Q10 (Part No. IPD250N06N3) with their source terminals connected together and to ground as shown. The drain terminal of MOSFET Q8 is connected to the 24 V AC line, while the drain terminal of MOSFET Q10 is connected to the HVAC system's control panel. The gate terminals of the MOSFETs Q8 and Q10 are connected to and driven by the collector terminals of BJT transistors Q9 and Q11 (Part No. BC846AT), respectively, which collector terminals are in turn connected to a 10 V power line provided by the high-voltage generator 406 (see FIG. 8D) through resistors R17 and R23, respectively. The base terminal of transistor Q9 is connected to pin 6 of the microcontroller through a resistor R20 and receives the upper MOSFET control signal (UPPER_FET_OFF), while the base terminal of transistor Q11 is connected to pin 9 of the microcontroller through a resistor R24 and receives the lower MOSFET control signal (LOWER_FET_OFF). The lower MOSFET control signal (LOWER_FET_OFF) from pin 9 of the microcontroller is also connected to a network of components comprising resistors R8, R9, R10, and R13; BJT transistors Q4 and Q6 (Part No. BC846AT); MOSFET Q5 (Part No. IPD250N06N3); and diode D9 (Part No. 1N4148WS), all connected to one another in the manner shown in FIG. 8C. Resistor R8 is further connected to the 10 V power line. This arrangement effectively results in MOSFET Q5 and MOSFET Q8 being in parallel with one another, but with MOSFET Q5 connected in a configuration that does not allow it to be fully turned on or fully conducting.

In some embodiments, a parallel component network composed of (i) a transient voltage suppressor D12 (Part No. SMBJ54CA) for suppressing any transient voltages appearing on the 24 V AC line, and (ii) a series connection of LED D14 (Part No. 1N4148WS), resistor R18, and LED D14, may be connected in parallel with the MOSFETs Q8 and Q10 as shown. The LED D14 operates (lights up) to indicate whenever there is no power to the HVAC system's control panel for any reason.

FIG. 8D illustrates an implementation 830 of the high-voltage generator 406 according to the disclosed embodiments. As can be seen, the high-voltage generator 406 may include a series connection of six diodes D4, D5, D6, D7, D8, and D18 (all Part No. 1N4148WS), with each diode's cathode connected to the next diode's anode, as shown. The anode of the first diode in the series, D4, is connected to the 3.3 V power line, and the cathode of the last diode in the series, D18, is connected to the 10 V power line. Capacitors C6, C8, and C15 each have one terminal that is connected to the cathodes and anodes, respectively, of diodes D4 & D5, D6 & D7, and D8 & D18, and the other terminal connected to the first charge pump signal (CHARGE_PUMP1) of the microcontroller, pin 6. Capacitors C7 and C9 each have one terminal connected to the cathodes and anodes, respectively, of diodes D5 & D6 and D7 & D8, and the other terminal connected to the second charge pump signal (CHARGE_PUMP2) of the microcontroller, pin 7. A sixth capacitor C10 has one terminal connected to the cathode of the last diode D18 and the 10 V power line and the other terminal connected to ground. As can be seen, when operated by the microcontroller, each junction between successive diodes D4, D5, D6, D7, and D8 has an incrementally higher voltage than the previous junction when the various capacitors C6, C7, C8, C9, and C15 are charged. In the depicted implementation, the voltage at each junction is approximately 2 V, 4 V, 6 V, and 8 V, respectively, as shown, with the voltage at the junction between diode D8 and D18 being approximately 10 V. The voltage at the cathode of diode D18 is therefore approximately 10 V. This 10 V supply line may then be used to shift the voltage level at the gates of MOSFETs Q8 and Q10 from a standard logic level up to a MOSFET logic level for any signals provided to the MOSFETs Q8 and Q10.

FIG. 8E illustrates an implementation 840 of the primary and auxiliary sensor logic 414 and 416 for the liquid sensor probes (not expressly shown) according to the disclosed embodiments. The implementation 840 of FIG. 8E is virtually identical to the implementation 740 of FIG. 7E, except that the component labels and part numbers have changed and the 3.3 V power line has been replaced by the LEAK_SENSOR_POWER signal from the microcontroller. Therefore, a detailed description of this particular implementation 840 is omitted here for economy purposes.

In normal operation, referring back to FIG. 8C, power MOSFETs Q8 and Q10 are turned on via the upper and lower MOSFET signals (UPPER_FET_OFF and LOWER_FET_OFF) to provide a high-voltage (e.g., 10 V) at their gate terminals, causing them to conduct current in an alternating fashion according to the positive and negative halves of the AC cycle. When condensate overflow is detected at the liquid sensor probes, the microcontroller turns off MOSFETs Q8 and Q10 by grounding their gate terminals, thereby putting them into a non-conducting state to cut power to the HVAC control panel and preventing further overflow.

When it is time to recharge the DC power supply 404, MOSFET Q8 is turned off, but MOSFET Q10 is left on and conducting. As a result, current tries to continue flowing through MOSFET Q10 by flowing through MOSFET Q5, which is in parallel with now non-conducting MOSFET Q8. However, MOSFET Q5 is configured such that a portion of the voltage on its drain terminal is fed back to its gate terminal, preventing MOSFET Q5 from fully turning on. In particular, diode D9, transistor Q4, and the combination of resistors R9 and R10 create a Zener effect that clamps the voltage drop across the source and gate terminals of MOSFET Q5. As a result, in the illustrated embodiment, MOSFET Q5 develops a voltage differential of about 5 V between its drain and source terminals during the positive half of the AC cycle. This voltage is regulated to about 3.3 V at the reservoir capacitors C3, C4, and C5 by a voltage regulator composed of transistor Q1 and Zener diode D2 (see FIG. 8B). Once charging is completed (i.e., the charge timer has elapsed), the microcontroller turns MOSFET Q8 back on and current begins to flow again through MOSFETs Q8 and Q10.

During the negative half cycle of the charging process, the body diode of power MOSFET Q5 conducts, resulting in a voltage drop of about 1 volt between the Q5 source and drain terminals. This lower voltage drop (i.e., lower than the 5V drop during the positive half cycle of the charging process) minimizes power loss in MOSFET Q5.

With respect to LED D14 and the current limiting resistor R18 placed across the power switch, if MOSFETs Q8 and Q10 are off (e.g., due either to an internal fault or because the microcontroller has detected condensate overflow and has shut them off), this LED D14 will light up, indicating to the user that the HVAC system has been electrically disconnected. Note also that if the microcontroller malfunctions and is unable to operate the charge pump circuitry of the high-voltage generator 406, the power MOSFETs Q8 and Q10 will be turned off due to a lack of a 10 V gate drive, thereby electrically disconnecting HVAC system. Transistor Q4 will similarly turn off if the microcontroller malfunctions so that MOSFET Q5 will also be in a non-conducting state.

With respect to LEDs D3 and D17, these LEDs may be operated by programming the microcontroller in the manner desired. For example, the microcontroller may be programmed to control LED D3, which may be a green LED, so as to indicate the status of the condensate overflow switch circuit, such as slow blink for normal operation, rapid blink for condensate detection, and the like. LED D17 may be controlled to indicate a short-term (e.g., several days) history of condensate detection or other faults to alert the user to the number of detections or faults recently experienced by the circuit. In the implementation shown, both LED D3 and D17 may employ Darlington configured NPN transistors to minimize power usage.

In addition, it is possible in some embodiments to implement the power-siphoning scheme of FIGS. 8A-8E using only two power MOSFETs instead of three. For example, such an embodiment may employ a three-state gate drive control scheme that uses additional electronics to drive the upper power MOSFET Q8 to one of three possible states: 1) Off state by applying 0 V at the gate terminal, 2) On state by applying 10 V at the gate terminal, and 3) Drain-Feedback state to achieve a fixed voltage differential across the source and drain terminals. In such an embodiment, there is no need to provide a separate power siphoning MOSFET Q5, as the upper power MOSFET Q8 can also provide the power siphoning function that would otherwise be provided by the MOSFET Q5.

While the disclosed embodiments have been described with reference to one or more particular implementations, those skilled in the art will recognize that many changes may be made thereto. Therefore, each of the foregoing embodiments and obvious variations thereof is contemplated as falling within the spirit and scope of the disclosed embodiments, which are set forth in the following claims.

1. A non-polarized controller for a liquid overflow switch, comprising:
a transistor-based switch connected to an AC power line, the transistor-based switch configured to connect the AC power line electrically to a load and to disconnect the AC power line electrically from the load;
a microprocessor connected to the transistor-based switch, the microprocessor configured to control the transistor-based switch to electrically disconnect the AC power line from the load upon occurrence of a predefined event; and
a DC power supply providing power for the microprocessor and the transistor-based switch, the DC power supply connected to the AC power line and configured to be periodically recharged using power from the AC power line.

2. The non-polarized controller according to claim 1, further comprising sensor logic connected to the microprocessor, the sensor logic configured to receive a signal from a liquid sensor probe and provide the signal to the microprocessor.

3. The non-polarized controller according to claim 4, wherein the predefined event includes the microprocessor receiving a signal from the sensor logic and determining, based on the signal, that the liquid sensor probe has come into contact with a liquid.

4. The non-polarized controller according to claim 1, further comprising a high-voltage generator connected to and receiving a voltage from the DC power supply, the high-voltage generator configured to generate a higher voltage than the voltage from the DC power supply using the voltage from the DC power supply.

5. The non-polarized controller according to claim 6, wherein the transistor-based switch includes power MOSFETs having low on-state resistance, further comprising a level shifter connected to the microprocessor and configured to shift a signal from the microprocessor from a standard logic level to a power MOSFET-compatible logic level using the higher voltage generated by the high-voltage generator.

6. The non-polarized controller according to claim 1, further comprising a zero crossing detector connected to the microprocessor and the AC power line and configured to provide a signal to the microprocessor when a zero crossing occurs in a voltage of the AC power line.

7. The non-polarized controller according to claim 8, wherein the microprocessor is configured to initiate recharging of the DC power supply upon receiving a signal from the zero crossing detector indicating occurrence of a negative-to-positive zero crossing in the voltage of the AC power line.

8. The non-polarized controller according to claim 1, wherein each time the DC power supply is recharged, the recharge interval lasts no longer than one of: approximately one-half of a standard cycle of the AC power line, or approximately half a millisecond.

9. The non-polarized controller according to claim 1, wherein the load is a heating, ventilating, and air conditioning (HVAC) system and the liquid overflow switch is an electronic condensate overflow switch for the HVAC system.

10. A method of detecting a potential liquid overflow condition using a non-polarized liquid overflow switch in an HVAC system, comprising:
receiving a signal from a liquid sensor probe by a microprocessor in the liquid overflow switch, the signal indicating that the liquid sensor probe has come into contact with a liquid;
determining by the microprocessor whether the signal has satisfied a predefined condition;
treating the signal as a false indication of a liquid overflow condition by the microprocessor if the signal has not satisfied the predefined condition; and
opening a transistor-based switch in the liquid overflow switch by the microprocessor to shut off the HVAC system if the signal has satisfied the predefined condition.

11. The method according to claim 10, further comprising initiating recharging of a DC power supply in the liquid overflow switch by the microprocessor upon occurrence of a predefined event.

12. The method according to claim 11, wherein recharging of the DC power supply includes electrically interrupting an AC power line of the HVAC system to at least partially divert power from the AC power line to the DC power supply.

13. The method according to claim 11, wherein recharging of the DC power supply includes creating a voltage differential across the transistor-based switch to charge the DC power supply.

14. The method according to claim 11, wherein the predefined event includes a negative-to-positive zero crossing of the voltage from the AC power line.

15. A non-polarized electronic condensate overflow switch for an HVAC system, comprising:
a mounting structure configured to be attached to a drain pan of the HVAC system;
a housing secured to the mounting structure;
one or more liquid sensor probes extending from the housing down to the drain pan; and
a processor-based controller connected to the one or more liquid sensor probes, the processor-based controller configured to:
receive a signal from the one or more liquid sensor probes, the signal being generated when the one or more liquid sensor probes contact a liquid;
determine whether the signal represents a valid indication of a liquid overflow condition; and
open a transistor-based switch in the electronic condensate overflow switch if the signal represents a valid indication of a liquid overflow condition.

16. The non-polarized electronic condensate overflow switch of claim 15, wherein the mounting structure is one of: a bracket configured to be attached to a wall of the drain pan, or an in-line unit configured to be connected in line with a condensate outlet of the drain pan.

17. The non-polarized electronic condensate overflow switch of claim 15, wherein the processor-based controller includes one or more of: a microprocessor, a microcontroller, a field programmable gate array (FPGA), and an application-specific integrated circuit (ASIC).

18. The non-polarized electronic condensate overflow switch of claim 15, wherein the transistor-based switch includes power MOSFETs connected so that the power MOSFETs share a common source terminal.

19. The non-polarized electronic condensate overflow switch of claim 15, wherein the processor-based controller is located according to one of the following: within the housing, or at a location physically separate from the drain pan.

20. The non-polarized electronic condensate overflow switch of claim 15, wherein the processor-based controller is further configured to recharge one or more reservoir capacitors using power from an AC power line on a periodic basis.
